(19) United States
(12) Patent Application Publication
(10) Pub. No.: US 2015/0262256 A1
(43) Pub. Date: Sep. 17, 2015

(54) COLLABORATIVE INSIGHTS FOR ADVERTISEMENT VIEWERS

(71) Applicant: Microsoft Corporation, Redmond, WA (US)

(72) Inventor: Shaojian He, Bellevue, WA (US)

(73) Assignee: Microsoft Corporation, Redmond, WA (US)

(21) Appl. No.: 14/209,408

(22) Filed: Mar. 13, 2014

(51) Int. Cl. G06Q 30/02

(52) U.S. Cl. CPC G06Q 30/0276; G06Q 30/0242; G06Q 30/0246

(57) ABSTRACT

Systems, methods, and computer-readable storage media for managing advertisement viewer feedback are provided. The system includes a database and a server. The database stores advertisement data, including metrics, for each advertisement. The servers provide advertisements to an advertisement viewer. In turn, the server receives actions from the advertisement viewer in response to the advertisement. The metrics for the advertisement are provided for display based on actions received from the advertisement viewer. The advertisement is rendered such that upon user interaction the metrics become viewable by the user. Theses metrics may include collaborative insights that are measured from one or more other users with similar interests to the user viewing the selected advertisement.

### BACKGROUND

Conventionally, content providers use advertisements to generate revenue in return for presenting an area for potential customers to interact with programs or service identified in the advertisements. The advertisements are displayed across static content (newspapers, journals, websites, shirts, mugs, etc.) that the content providers produce. It is desirable to assure advertisers that their viewers review the advertisement presented and that advertisements are targeted to the correct viewers.

Social networking is one way that advertisers target potential customers. The increasing popularity of social networking provides many opportunities for advertisers to reach potential customers. One conventional technique is “open graph” offered by FACEBOOK™, INC. of Palo Alto, Calif., which allows content administrators to place endorsements or “Like” buttons on their websites. By selecting a “Like” button, users share with their social network connections that they positively endorse the represented entity (for instance, a movie, a celebrity, etc.). However, “Like” endorsement data tends to be very sparse (few “Likes” per page), and it is difficult to know whether the desired individuals are being reached via a broadcast within the endorsing user's network connections (e.g., the endorsing user may have few connections).

Beyond websites with social networking components (e.g., “Like”), advertisement viewers have difficulty understanding the effectiveness of an advertisement. For instance, during international and national events (e.g., Olympics, World Cups, World Series, US Open, etc.), advertisers secure premium slots from strategic content providers to engage captive audiences. During or soon after these events, some advertisement viewers may wish to see these advertisements and may be curious about whether the advertisements were effective or engaging.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the invention relate to systems, methods, and computer-readable storage media for, among other things, providing advertisement viewers with insights into an advertisement's engagement with other advertisement viewers. In at least one embodiment, the advertisement may include metrics that measure a level of current advertisement viewer engagement with the advertisement. In some embodiments, the advertisement metrics are viewable or previewable based on the type of actions received from the advertisement viewer.

The server, in some embodiments, obtains the metrics and advertisements from a database. The database may store, among other things, advertisement data, including metrics, for each advertisement. The metrics, in some embodiments, include advertisement ratings (1-Excellent, 2-Good, 3-Neutral, 4-Poor, 5-Bad, etc.) and comments from the advertisement viewer. The metrics may also include an indication of a number of content providers that have displayed the advertisement to advertisement viewers. In other embodiments, metrics may also include an indication of a type (print, web, mobile, desktop, gaming, etc.) for each content provider that displayed the advertisement to advertisement viewers. The server provides the advertisements to an advertisement viewer. In response to actions targeting the advertisement and received from the advertisement viewer, the server may render metrics for the advertisement.

### BRIEF DESCRIPTION OF THE DRAWINGS

Embodiments of the invention are illustrated by way of example and not limitation in the accompanying figures in which like reference numerals indicate similar elements and in which:

FIG. 1 is a block diagram of an exemplary computing environment suitable for use in implementing embodiments of the invention;

FIG. 2 is a network diagram of an exemplary computing system in which embodiments of the invention may be employed;

FIG. 3 is a logic diagram of an exemplary method for providing advertisement metrics to advertisement viewers in accordance with embodiments of the invention;

FIG. 4 is a schematic diagram illustrating an exemplary screen display of the advertisements and corresponding metrics in accordance with embodiments of the invention;

FIG. 5 is another schematic diagram illustrating an exemplary advertisement and corresponding metrics in accordance with embodiments of the invention;

FIG. 6 is a table illustrating exemplary metrics available for each advertisement provided in accordance with embodiments of the invention; and

FIG. 7 is a communication diagram illustrating the exchange of data between the advertisement viewers and a server in accordance with embodiments of the invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” or “component,” etc., might be used herein to connote different components of methods or systems employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, generating an advertisement with one or more metrics for display to an advertisement viewer based on the interaction between the advertisement viewer and the generated advertisement.

The metrics, in certain embodiments, are generated with the advertisements. The metrics include, among other metrics, explicit advertisement viewer feedback.

The availability of these metrics may increase user interaction with advertisements which may yield higher click or conversion rates for the generated advertisement. The metrics may provide collaborative insights from the advertisement viewers. In certain embodiments, the placement of the metrics is dependent on the level of user interaction with the generated advertisement. These metrics may provide collaborative insights for advertisement viewers (CIAV). The collaborative aspect becomes apparent because the current advertisement viewer feedback and other metrics are shareable with other advertisement viewers.

The shared metrics allow the advertisement viewer to gain insights into how other advertisement viewers interacted with the advertisement and their reactions. Based on the availability of the metrics, an advertisement viewer may be able to assess, in at least one embodiment, whether an advertisement has received good feedback (e.g., positive ratings); is popular (e.g., one that advertisement viewers pay attention to); is authentic; or is new (e.g., recently added to the advertisement database or is now being rendered for display for the first time to the current advertisement viewer).

In certain embodiments, a server is configured to collect advertisement viewer metrics and server metrics for each advertisement in an advertisement database. The metrics measure various interactions with the advertisements by the advertisement viewer. For instance, the metrics include viewing, hovering, clicking, converting, commenting, and other viewer behaviors related to the advertisements. Based on the interaction from the advertisement viewer, the server may provide a count of several interactions, including but not limited to number of advertisement views, number of hovers over the advertisement, number of clicks on the advertisement, number of conversions for the advertisement, etc. The count may include an engagement throughput rate (ETR).

In addition to the counts, the server may provide or solicit comments and ratings for the current advertisement with which the advertisement viewer is interacting. In some embodiments, the advertisement's freshness may also be displayed. For instance, if the advertisement was recently entered (e.g., less than three days ago) into the advertisement database, when that advertisement is selected for display, it may be marked with a “NEW” tag by the server.

In at least one embodiment, the count of the ETR may indicate how interesting or useful the advertisement is for the other viewers. The ETR metric, as opposed to click throughput rate (which assesses advertisement clicks), includes other actions, such as hovering, commenting, rating, etc.) Each action will be weighed when calculating the ETR, with larger weights applied to actions that lead to more conversions.

The metrics for each advertisement are stored and rendered for display by the server. The advertisement interaction may include user interface to obtain shareable feedback during advertisement rendering. Accordingly, the server may display the collected metrics and feedback for each advertisement to advertisement viewers that interact with the advertisement.

Having briefly described an overview of embodiments of the invention, an exemplary operating environment in which embodiments of the invention may be implemented is described below in order to provide a general context for various aspects of the present invention.

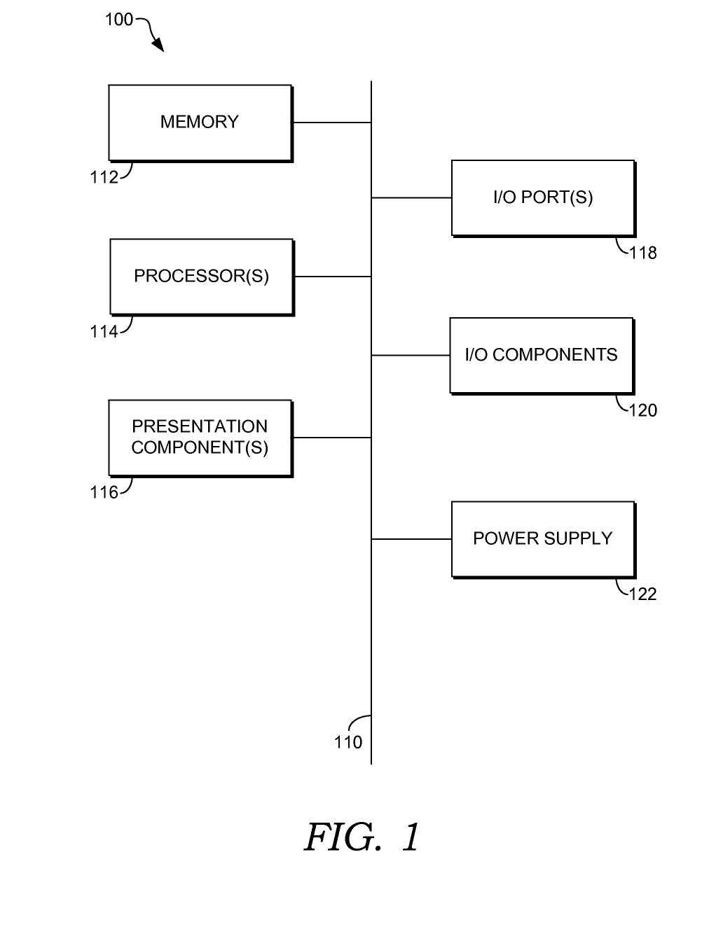

FIG. 1 is a block diagram of an exemplary computing environment suitable for use in implementing embodiments of the invention. Referring to the figures in general and initially to FIG. 1 in particular, computing device 100 is illustrated. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

The embodiments of the invention may be described in the general context of computer code or machine-useable instructions, including computer-executable instructions, such as program components, being executed by a computer or other machine, such as a personal data assistant or other hand-held device. Generally, program components, including routines, programs, applications, objects, components, data structures, and the like, refer to code that performs particular tasks or implements particular abstract data types. Embodiments of the invention may be practiced in a variety of system configurations, including hand-held devices, tablet computers, consumer electronics, general-purpose computers, specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes memories and processors configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows a device to select one or more advertisements for display to an advertisement viewer. The device is configured to generate advertisements that are configured to reveal statistical metrics about the advertisement's performance based on an advertisement's viewer interaction. The device may render metrics, including ETR, of the advertisements, for display to advertisement viewers. The device may, in an embodiment, obtain comments and ratings from advertisement viewers for sharing with other advertisement viewers.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component, such as a display device, to be an I/O component. Also, processors have memory. The inventors hereof recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and refer to “computer” or “computing device.”

Computing device 100 typically includes a variety of computer-readable media. Computer-readable media can be any available media that is accessible by computing device 100 and includes both volatile and non-volatile media and removable and non-removable media. Computer-readable media may comprise computer storage media and communication media.

Computer storage media includes volatile and non-volatile and removable and non-removable media implemented in any method or technology for storage of information, such as computer-readable instructions, data structures, program modules, or other data. Computer storage media includes, but is not limited to, random access memory (RAM), read-only memory (ROM), electronically erasable programmable read-only memory (EEPROM), flash memory or other memory technology, CD-ROM, digital versatile disks (DVDs) or other holographic memory, magnetic cassettes, magnetic tape, magnetic disk storage or other magnetic storage devices, or any other medium that can be used to encode desired data and that can be accessed by the computing device 100. In an embodiment, the computer storage media can be selected from tangible computer storage media like flash memory. These memory technologies can store data momentarily, temporarily, or permanently. Computer storage media does not include and excludes communication media.

On the other hand, communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media.

Memory 112 includes computer storage media in the form of volatile and/or non-volatile memory. The memory may be removable, non-removable, or a combination thereof. Exemplary hardware devices include solid-state memory, hard drives, optical-disk drives, etc. Computing device 100 includes one or more processors 114 that read data from various entities, such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, controller (such as a stylus, keyboard, and mouse), or natural user interface (NUI), etc.

The NUI processes gestures (e.g., hand, face, body, etc.), voice, or other physiological inputs generated by an advertisement viewer. These inputs may be interpreted as queries, requests for selecting advertisements, or requests for interacting with an advertisement (e.g., display advertisement, banner advertisement, search advertisement, etc.). In one embodiment, the advertisement may be included as a search result. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and gaze recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

As previously mentioned, embodiments of the invention are generally directed to systems, methods, and computer-readable storage media for, among other things, receiving advertisement viewer feedback and rendering the metrics with the advertisement based on the advertisement viewer feedback. In some embodiments, the interaction with advertisements may be received by the computing device via the NUI. The metrics, in some embodiments, are rendered as part of the advertisement. In other embodiments, a statistics frame or dialog may be generated for display to the advertisement viewer, for instance, in response to advertisement viewer interaction with the advertisement.

Various aspects of the technology described herein are generally employed in computer systems, computer-implemented methods, and computer-readable storage media for, among other things, generating advertisements. In one embodiment, a server executes an analysis component that calculates various counts for the advertisements that are selected for rendering and transmission to an advertisement viewer. The server may process the collected metrics, including clicks, hovers, and ratings, to measure the current performance of the advertisement. The rendering component executed by the server may determine whether the metrics are transmitted to client computing devices of the advertisement viewers.

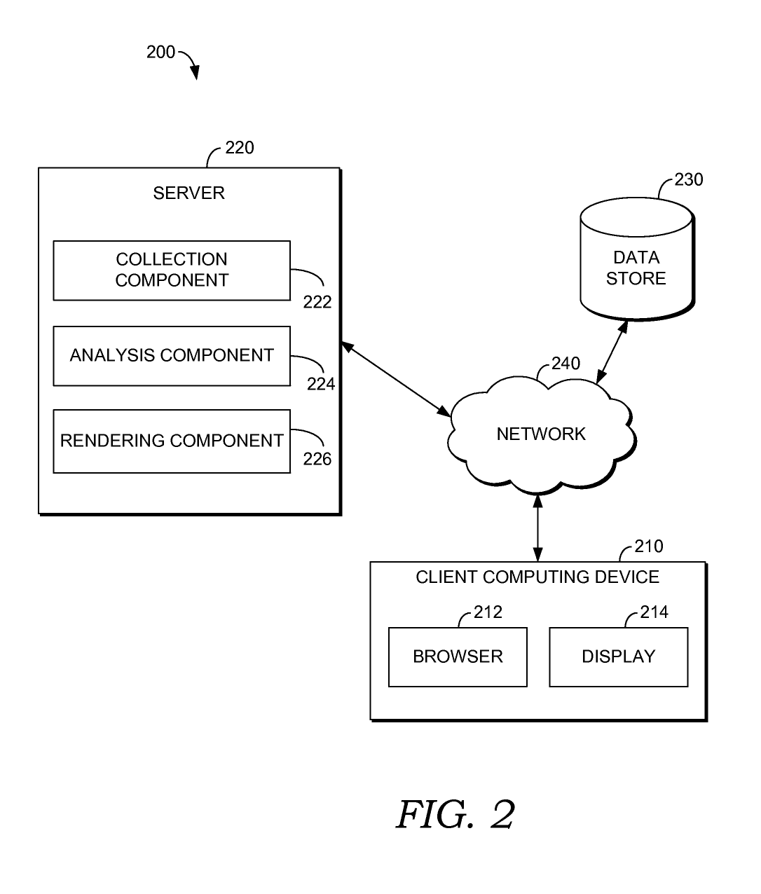

FIG. 2 is a network diagram of an exemplary computing system 200 in which embodiments of the invention may be employed. The computing system 200 may include a client computing device 210, a server 220, a data store 230, and a network 240. The network 240 communicatively connects the client computing device 210, server 220, and data store 230 to each other. It should be understood that any number of client computing devices and servers may be employed in the computing system 200 within the scope of embodiments of the present invention. Each may comprise a single device/interface or multiple devices/interfaces cooperating in a distributed environment. For instance, the server 220 may comprise multiple devices and/or modules arranged in a distributed environment that collectively provide the functionality of the server 220 described herein. Additionally, other components/modules not shown also may be included within the computing system 200.

The client computing device 210 may include any type of computing device, such as the computing device 100 described with reference to FIG. 1, for example. Generally, the client computing device 210 includes a browser 212 and a display 214. The browser 212, among other things, is configured to allow advertisement viewers to view search engine home pages (or other online landing pages) and to allow advertisement viewers to view search engine results pages having advertisements on the display 214 of the client computing device 210. The browser 212 is further configured to receive advertisement viewer input for requests including various web pages (including search engine home pages), to receive advertisement viewer inputted search queries (generally inputted via a user interface presented on the display 214 and permitting alphanumeric and/or textual input into a designated search box), and to receive content (e.g., advertisements) for presentation on the display 214, for instance, from the server 220. The client computing device 210 may receive the advertisements for display to the advertisement viewer. The advertisement may be generated with one or more metrics. In at least one embodiment, in response to advertisement viewer interaction with the advertisement, additional metrics corresponding to the advertisement become viewable. It should be noted that the functionality described herein as being performed by the browser 212 may be performed by any other application capable of rendering multimedia content.

The server 220 is configured to receive and respond to requests that it receives from components associated with client computing device 210, for instance, the browser 212 associated with the client computing device 210. Those skilled in the art of the various embodiments of the invention will recognize that the illustrated components may be implemented with any number of searching utilities. For example, an Internet search engine or a database search engine may utilize the embodiments of the invention. These search engines are well known in the art, and commercially available engines share many similar processes not further described herein.

As illustrated, the server 220 includes a collection component 222, an analysis component 224, and a rendering component 226. The server 220 may determine the ETR for advertisements that are selected for display to a client computing device 210. In some embodiments, the ETR is a weighted sum of counts corresponding to advertisement viewer interactions with the advertisement. For instance, the weight for counted hover actions may be less than the weight applied to the counted click actions. The weighted sum of the collected interactions may be used to calculate the ETR.

The collection component 222 receives input from the client computing device 210. The collection component 222 may allow the system to learn about the advertisement viewer. In one embodiment, the collection component 222 may receive purchase transaction data corresponding to products included in the advertisements. This purchase transaction data may be collected from third-party vendors. In some embodiments, the counts may correspond to advertisements that are provided in several formats (e.g., print, television, and Internet). The advertisements may include metrics that include cost of advertisement slot, advertisement length, number of advertisement viewers that interacted with the advertisement, etc.

The print advertisements may include interactive codes (e.g., bar codes or QR codes that may be scanned by the advertisement viewer's computing device to initiate a transaction or to view advertisement metrics corresponding to the print advertisement). The print advertisements may have metrics that are collected that include full page, half page, section of paper, and article that accompanied advertisement, if any. The advertisement viewer may provide feedback on the print advertisement via the computing device.

The television advertisements may include metrics like number of times displayed in a day and metrics that define the type of premium content programming (horror, sport, comedy, news, etc.) that are rendered after the advertisement. The television advertisements may be evaluated by the advertisement viewer via the computing device. The computing device displays a feedback dialog in response to user interaction with the television advertisement (e.g., click, hover, etc).

The Internet advertisements may include many of the same metrics discussed above and click metrics, hover metrics, and explicit advertisement viewer feedback (e.g., ratings: 1-5, 1 being best and 5 being worst; and comments: advertisement viewer suggestions). The collection component 222 may, in some embodiments, calculate a footprint for an advertisement by determining the number and type of devices that are used by the advertisement viewers to view the advertisements (e.g., mobile device, gaming device, desktop, addressable televisions, etc.). The Internet advertisements are interacted with by the advertisement viewer to navigate to an advertiser's web site. While on the advertiser's website, the advertisement viewer may initiate a purchase of a product referenced in the advertisement or any other product. The advertiser may collect the purchase data and an identifier of the advertisement from where the advertisement viewer navigated form. The purchase information may identify the product or products purchased by the advertisement viewer. In turn, in at least one embodiment, the advertiser may provide the purchase, product, and advertisement information to the server 220 for consideration when evaluating the metrics for the advertisement.

The analysis component 224 may evaluate the metrics for the advertisements interacted with by advertisement viewers. The analysis component 224 may receive the metrics from the collection component 222 or the advertisers. The collection component 222 provides the metrics received from multiple advertisement viewers and for the available formats of the advertisement. The aggregated metrics are used to determine the ETR for each advertisement viewed by the advertisement viewer. A sample of the aggregated metrics includes advertisement freshness (e.g., the age of the advertisement). In one embodiment, freshness is based on the first time an impression (e.g., view by the advertisement viewer) is received for the advertising. In another embodiment, freshness is defined based on the date an advertiser adds the advertisement into rotation among its media outlets.

Other aggregated metrics may include the number of times the advertisement has been viewed across different media formats (e.g., print, television, etc.) or different client devices (e.g., mobile, desktop, etc.), the number of hovers, the number of clicks, or the number of conversions (e.g., click followed by a sale). Additional metrics corresponding to advertisement viewer actions may be aggregated, such as the number of searches on a product in the advertisement received contemporaneously with an advertisement viewer viewing the advertisement. The number of descriptions and the number of ratings in each category 1-5 for the advertisement is aggregated by the analysis component 224.

The analysis component 224 weighs the aggregated metrics and calculates the ETR by summing the weighted metrics. Based on the ETR, advertisement viewers may quickly determine an advertisement's overall performance. These metrics may be stored in the data store 230. The analysis component 224 may execute a fraud detection component to prevent bots (automated computers designed to act like advertisement viewers) and cheating. The fraud detection may include image challenges when gathering feedback, or IP address and location confirmation. This prevents fraudulent metrics from influencing the ETR.

The rendering component 226 may determine how, when, and where to display the metrics. The rendering component 226, in some embodiments, generates the advertisement with metrics that are placed at the bottom of the advertisement. In other embodiments, the rendering component 226 places the metrics at the top of the advertisement. The rendering component 226, in still another embodiment, may display additional metrics in response to advertisement viewer interaction with the advertisements. For instance, in response to a hover, a dialog may be presented that displays additional metrics (e.g., ratings, freshness, number of conversions, etc). The rendering component 226 may vary the text location, color, or size in response to user interaction (e.g., clicking on the metrics may increase the size or change the color). In one embodiment, the advertisement may include a visual indicator like a triangle icon that once clicked or hovered over may open the dialog with additional metrics. The additional metrics may include a “since when” calculation, number of impressions, ETR, click throughput rate (CTR), number of likes, number of not likes, and number of descriptions from advertisement viewers. In some embodiments, the dialog may be configured to request feedback from the current advertisement viewer. The feedback may include like, not like, ratings (1-5), or comments.

In some embodiments, rendering component 226 may include a link to other advertisements related to the advertiser when generating the advertisement. Additionally, other links may be generated with the advertisement, for instance, top like (e.g., most liked advertisements) or top new (e.g., newest advertisements based on freshness). Upon aggregating the metrics, the server 220 is able to provide a listing of the top likes and top new advertisements across media types and device types.

The data store 230 stores the advertisement and the corresponding metrics for each advertisement. The metrics, as explained above, include media type; device type; number of clicks, hovers, ratings, comments, likes, not likes, CTR, and ETR; etc. The data store 230 is accessed by the server 220 to obtain the advertisements and metrics. In some embodiments, the metrics are updated in the data store 230 as additional advertisement viewer interaction is collected.

The network 240 may include, without limitation, one or more local area networks (LANs) and/or wide area networks (WANs). Such networking environments are commonplace in offices, enterprise-wide computer networks, intranets, and the Internet. Accordingly, the network 240 is not further described herein.

In some embodiments, one or more of the illustrated components/modules may be implemented as stand-alone applications. In other embodiments, one or more of the illustrated components/modules may be implemented via the client computing device 210, as an Internet-based service, or as a module inside the server 220. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of search engines or user computing devices. By way of example only, the server 220 might be provided as a single server (as shown), a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

A server device may execute instructions stored on computer storage media for generating advertisements and corresponding metrics. The server may collect the metrics based on interactions with other advertisement viewers. The metrics are aggregated for each advertisement by the server. In turn, the server may selectively display the metrics with advertisements that are rendered for display to subsequent advertisement viewers.

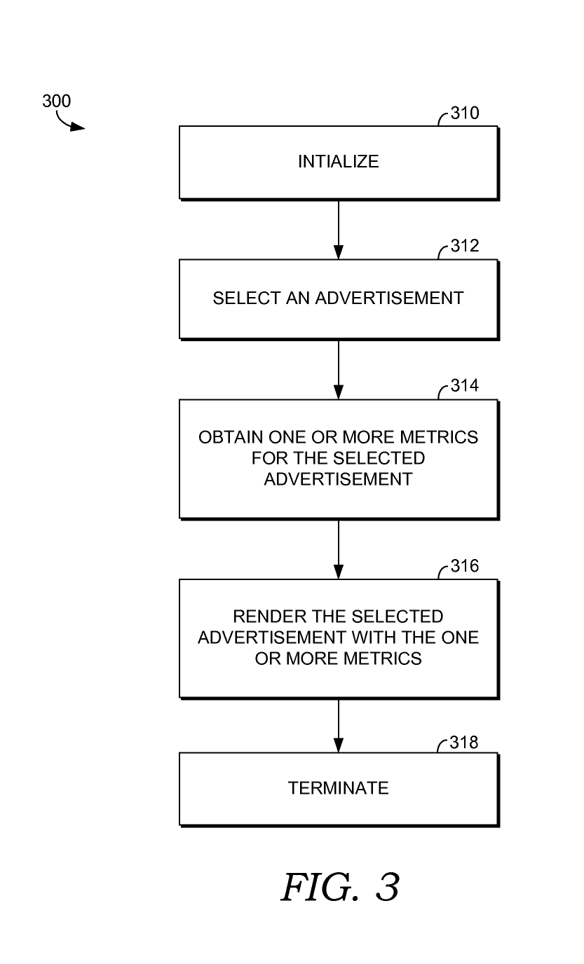

FIG. 3 is a logic diagram of an exemplary method 300 for providing advertisement metrics to advertisement viewers in accordance with embodiments of the invention. The method 300 initializes in step 310. In turn, a server is configured to select an advertisement in step 312. The server may collect one or more metrics, in step 314, for the selected advertisement. The metrics represent various measures of advertisement performance. In some embodiments, the metric includes ETR. In other embodiments, the metrics include collaborative insights that are measured from one or more other users with similar interests, based on previous advertisement history, to the user viewing the selected advertisement.

The server, in step 316, renders the selected advertisement such that upon user interaction the metrics become viewable by the user. The interaction includes an advertisement viewer hovering over the selected advertisement. In other embodiments, the interaction includes an advertisement viewer clicking on a portion of the selected advertisement.

The server may, when rendering the advertisement for display, provide a dialog to receive feedback from the advertisement viewer. The server may receive user feedback in response to the dialog. The dialog may be rendered in a graphical user interface with the selected advertisement. The method terminates in step 318.

Accordingly, the server is configured to collect raw behaviors related to the advertisements. The advertisements include text, graphics, or video provided by an advertiser. Each advertisement may have a unique identifier in the data store accessed by the server. The identifier may be used to store the appropriate advertisement viewer interaction with the advertisement user's behaviors. The advertisement viewer interactions are collected from all device types, including televisions, gaming devices, and mobile devices, and from each media provider, like the web pages, gaming, and applications.

The server processes the interaction to calculate the ETR and to determine which metrics to render with an advertisement. These metrics include the count of impressions, hovers, clicks, conversions, comments, ratings, etc. Based on the aggregated counts, the ETR may be calculated based on the predefined weight on each of the interactions. In some embodiments, the ETR and metrics for each advertisement may be loaded from the data store into the server memory for high performance.

The data store containing the advertisement organizes the metric per advertisement. If feasible and allowed (e.g., advertisement viewer privacy opt-in), the interaction and identifier of each advertisement viewer is mapped to the advertisement for future advertisement selection and ranking. For example, assume advertisement viewer 1 and advertisement viewer 2 have clicked on advertisement A. Advertisement viewer 1 clicks on advertisement B. The metrics of advertisement A are shown to advertisement viewer 2. The metrics of advertisement A may include a related advertisement link that includes related advertisements having advertisement B, which is ranked higher because of the click by advertisement viewer 1. In some embodiments, the identifier of the advertisement viewer is anonymized to protect the privacy of the advertisement viewer.

In one embodiment, the server may provide an advertisement viewer with a screen that renders advertisements for display. These advertisements may include top like advertisements and top new advertisements. The advertisements may each be displayed in a tile on a graphical user interface. The advertisement viewer may interact with one or more of the advertisements.

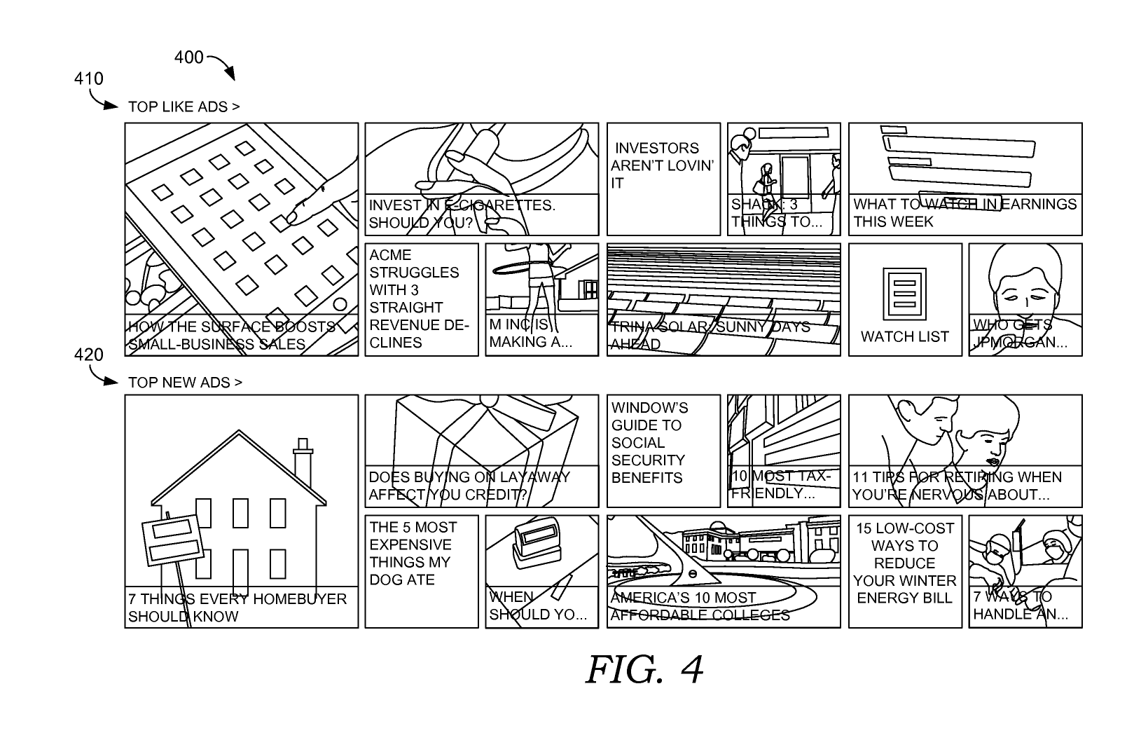

FIG. 4 is a schematic diagram illustrating an exemplary screen display 400 of the advertisements and corresponding metrics in accordance with embodiments of the invention.

The screen display 400 may include top like advertisements 410 and top new advertisements 420. The top like advertisements 410 include a selection of advertisements with the most likes from the advertisement viewers that viewed the advertisement. The top new advertisements 420 are the freshest advertisements. In one embodiment, the advertisements that are identified in the top like 410 and top new 420 may be grouped together in the screen display 400.

In additional embodiments, the server may provide an advertisement viewer with display advertisements, search advertisements, banner advertisements, etc. These advertisements may be generated with metrics that include, among other things, freshness and likes. The advertisements may be generated by the server for display on the computing device of the advertisement viewer.

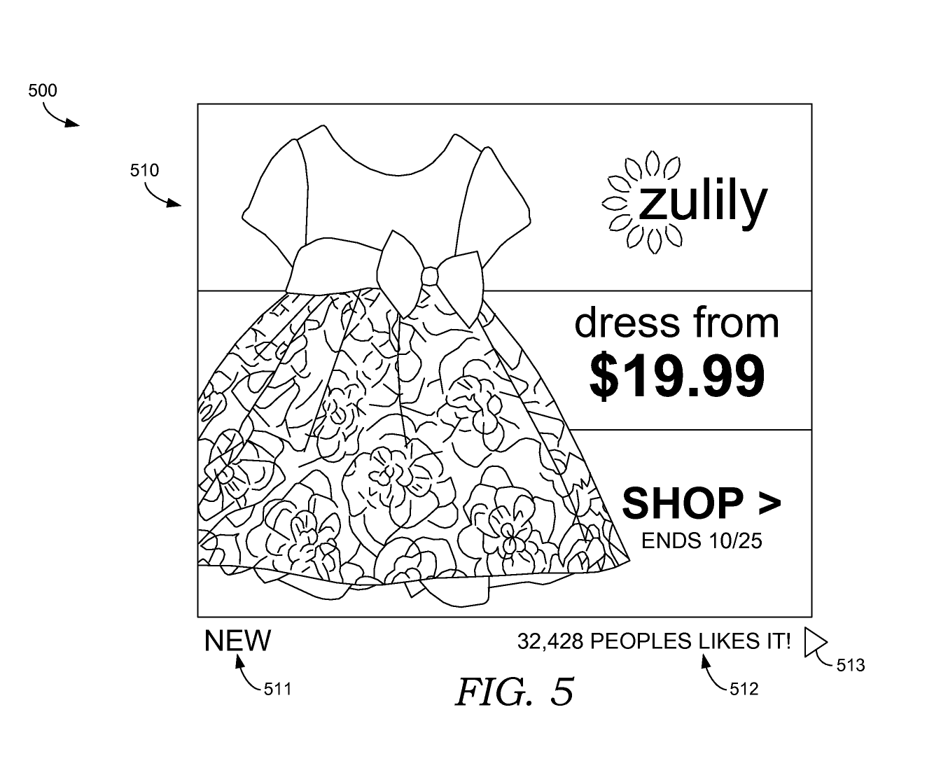

FIG. 5 is another schematic diagram illustrating an exemplary advertisement and corresponding metrics in accordance with embodiments of the invention. A screen display 500 may include the advertisement 510. The advertisement may be rendered with the freshness metrics 511, the like metrics 512, and a more metrics icon 513.

The location of the freshness metrics 511, likes metrics 512, and more metrics icon 513 may be varied by the server. For instance, the freshness metrics 511, likes metrics 512, and the more metrics icon 513 may be rendered in any one of the corners of the advertisement 510. Alternatively, the server may render the freshness metrics 511, likes metrics 512, and more metrics icon 513 at the middle of advertisement 510, the bottom of the advertisement 510, or the top of the advertisement 510.

The server may include text near the advertisement provided by the advertiser. In one embodiment, the server may render the following text “35,428 peoples like it.” This number may be the aggregate value of the likes for the advertisements calculated by the server. The server may measure the number of likes received from each advertisement viewer that viewed the advertisement 510 to arrive at the aggregate value. In one embodiment, if the advertisement 510 is a search advertisement, the server may only show the aggregate number of clicks by the advertisement viewer.

The server obtains additional metrics in response to advertisement viewer interaction with the more metrics icon 513. In response to a click on the more metrics icon 513 or a hover on the more metrics icon 513, a new screen may be displayed with the additional metrics. This screen may be separate from the screen displaying the advertisement 510 in at least one embodiment. In some embodiments, the screen may be a floating window that is temporarily displayed to the advertisement viewer. The screen may provide the advertisement viewer with additional details about the advertisement. The details page may define what like means and include other metrics (e.g., clicks, conversion, ETR, etc.).

The server generates the details page in response to the advertisement viewer interaction with the advertisement's more metrics icon 513. In other embodiments, an advertisement viewer interaction with any metric displayed with the advertisement may cause the server to generate the details page. The details page includes additional metrics and provides the advertisement viewer the option to provide feedback on the advertisement viewed by the advertisement viewer.

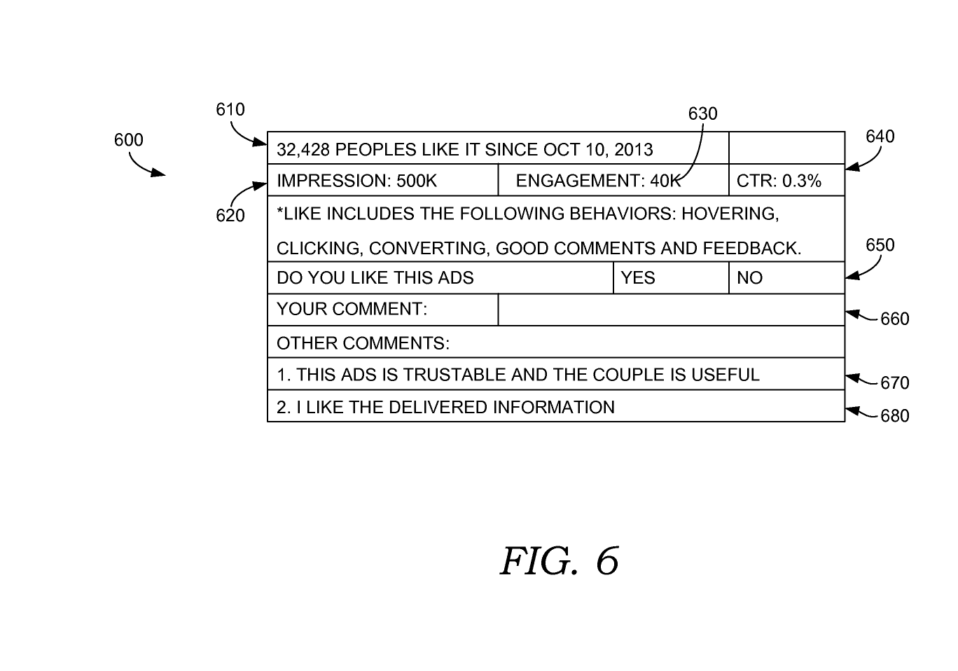

FIG. 6 is a table illustrating exemplary metrics available for each advertisement provided in accordance with embodiments of the invention. The details page 600 is generated by the server. The details page 600 includes, but is not limited to, freshness and like metrics 610, impression metrics 620, engagement throughput rate metrics 630, click throughput rate metrics 640, like feedback 650, comments 660, ratings 670 and 680. The advertisement viewer may provide like feedback 650, comments 660, and ratings 670 and 680 by entering selections or text for submission to the server. The advertisement viewer may only provide comments and ratings once in one embodiment. If an advertisement viewer previously provided comments, like feedback, or ratings, the values and text may be rendered for display by the server in the details page 600. Alternatively, the user is prohibited from providing additional comments, like feedback, or ratings, by the server, which grays out the comment, feedback or rating elements of the details page 600.

The freshness and like metrics 610 provide the advertisement viewer with a measure of how long this advertisement has been in the system and the other advertisement viewers' reactions it has received. The impression metrics 620 provide the number of views by other advertisement viewers. The engagement throughput rate metrics 630 provide a measure of the advertisement's overall performance. The click throughput rate metrics 640 provide a measure of the click performance of the advertisement.

According to embodiments of the invention, the advertisement viewer may interact with the advertisements in many different ways. For instance, the advertisement viewer may click, scan, gaze, like, hover, etc. on the advertisements. The server (configured according to embodiments of the invention) captures these interactions and calculates several metrics of the advertisements interacted with by the advertisement viewer. The metrics are made available to the advertisement viewer.

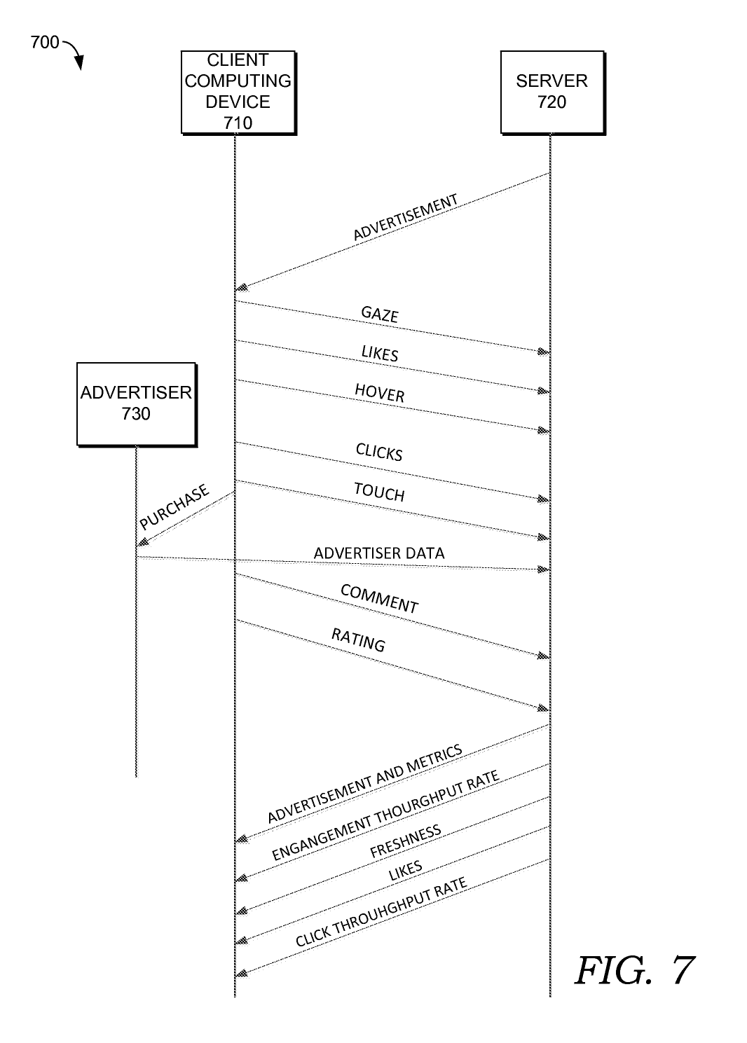

FIG. 7 is a communication diagram 700 illustrating the exchange of data between the advertisement viewers 710 and a server 720 in accordance with embodiments of the invention.

Initially, an advertisement viewer at client computing device 710 receives an advertisement from the server 720. The advertisement may not have any metrics readily available. In other embodiments, the advertisements may include at least one metric, e.g. freshness or popularity of the advertisement. In turn the advertisement viewer interacts with the advertisement.

The client computing device 710 may provide the advertisement viewer interactions to the server 720. The advertisement viewer interactions may include, but is not limited to, gaze at the advertisement, liking the advertisement, hovering over the advertisement, clicking on the advertisement, touching the advertisement, commenting on the advertisement, or rating the advertisement. These advertisement viewer interactions are received by the server 720 and analyzed.

In some embodiments, in addition to direct interaction information received from the advertisement viewers, the server 720 receives indirect interaction information from the advertisers. For instance, an advertisement viewer may purchase an item included in an advertisement from an advertiser's 730 website. In certain embodiments, the advertiser 730 may provide this advertiser data to the server 720 for consideration when calculating the metrics.

At the server 720, the metrics for engagement throughput rate, click throughput rate, likes, freshness, among others, are calculated. Once these metrics are calculated by the server 720, they are provided to the advertisement viewers with the advertisement. The metrics may be rendered by the client communication device 710 in a details page when requested by the advertisement viewer. The advertisement viewer may request the details page by hovering or clicking on an icon in the advertisement. The details page, in at least one embodiment, may be a separate page or a notification that is temporarily visible proximate to the advertisement.

In summary, embodiments of the invention provide a computer system for managing advertisement viewer feedback. The system comprises one or more databases and one or more servers. The database stores advertisement data, including metrics for each advertisement. The one or more servers are configured to provide advertisements to an advertisement viewer. The servers receive actions from the advertisement viewer in response to the advertisement. The metrics for the advertisement are provided for display based on actions received from the advertisement viewer. The text, location, color, or size of metrics may be varied by servers based on the action, wherein a hover action causes the server to provide a metrics preview and a click action causes the server to provide a dialog with detailed metrics about the advertisement.

In one embodiment, the metrics may be located at a bottom, a top, middle, a corner, or an edge of an advertisement by the servers. The metrics may include a measure of freshness. In some embodiments, freshness is measured by the servers based on when the advertisement was created by the advertiser. In another embodiment, freshness is measured by the servers based on whether the advertisement viewer has previously viewed the advertisement.

The metrics may include an indication of whether other advertisement viewers liked the advertisement such that a number of advertisement views or likes are provided by the server and the likes are based on a rating system. The indication of whether other advertisement viewers liked the advertisement includes calculating by the server the ETR that is based on an aggregate of the following measures: number of clicks, number of conversions, number of comments, and average rating for the advertisement. Each measure included in the calculation may be weighted by a predefined percentage.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

The technology claimed is:

1. One or more computer-readable storage media storing computer-useable instructions that, when used by one or more computing devices, cause the one or more computing devices to perform a method for generating an advertisement, the method comprising:
selecting an advertisement;
collecting one or more metrics for the selected advertisement; and
rendering the selected advertisement such that upon user interaction the metrics become viewable by the user.

2. The one or more computer-readable storage media of claim 1, wherein the metrics represent various measures of advertisement performance.

3. The one or more computer-readable storage media of claim 1, wherein the metrics include engagement throughput rate.

4. The one or more computer-readable storage media of claim 3, wherein the engagement throughput rate is an aggregate of number of various actions performed by the user viewing the selected advertisement.

5. The one or more computer-readable storage media of claim 1, wherein the metrics include collaborative insights that are measured from one or more other users with similar interests, based on previous advertisement history, to the user viewing the selected advertisement.

6. The one or more computer-readable storage media of claim 1, wherein the interaction includes an advertisement viewer hovering over the selected advertisement.

7. The one or more computer-readable storage media of claim 1, wherein the interaction includes an advertisement viewer clicking on a portion of the selected advertisement.

8. The one or more computer-readable storage media of claim 1, wherein rendering the advertisement for display includes providing a dialog to receive feedback from the advertisement viewer.

9. The one or more computer-readable storage media of claim 8, wherein rendering the advertisement for display includes receiving user feedback in response to the dialog.

10. The one or more computer-readable storage media of claim 8, wherein the dialog is rendered in a graphical user interface with the selected advertisement.

11. A computer system for managing advertisement viewer feedback, the system comprising:
one or more databases having advertisement data, including metrics for each advertisement; and
one or more servers configured to provide advertisements to an advertisement viewer and to receive actions from the advertisement viewer in response to the advertisement, wherein the metrics for the advertisement are provided for display based on actions received from the advertisement viewer.

12. The system of claim 11, wherein the metrics are located at a bottom, a top, middle, a corner, or an edge of an advertisement.

13. The system of claim 12, wherein the metrics include a measure of freshness.

14. The system of claim 13, wherein freshness is measured based on when the advertisement was created by the advertiser.

15. The system of claim 13, wherein freshness is measured based on whether the advertisement viewer has previously viewed the advertisement.

16. The system of claim 12, wherein the metrics include an indication of whether other advertisement viewers liked the advertisement such that a number of advertisement views or likes are provided by the server and the likes are based on a rating system.

17. The system of claim 16, wherein the indication of whether other advertisement viewers liked the advertisement includes calculating an engagement throughput rate that is based on an aggregate of the following measures: number of clicks, number of conversions, number of comments, and average rating for the advertisement.

18. The system of claim 17, wherein each measure is weighted by a predefined percentage.

19. The system of claim 12, wherein the text, location, color, or size vary based on the action, wherein a hover action causes the server to provide a metric preview and a click action causes the server to provide a dialog with detailed metrics about the advertisement.

20. A computer-implemented method performed by one or more computing devices including at least one processor, for generating an advertisement, the method comprising:
selecting an advertisement;
obtaining one or more metrics for the selected advertisement; and
rendering the selected advertisement such that upon user interaction the metrics become viewable by the user, wherein the metrics include collaborative insights that are measured from one or more other users with similar interests to the user viewing the selected advertisement.
